(19) United States
(12) Patent Application Publication
(10) Pub. No.: US 2017/0329139 A1
(43) Pub. Date: Nov. 16, 2017

(54) METHOD AND NOTCH REFLECTOR PROJECTION SYSTEM

(71) Applicant: Fusar Technologies, Inc., Jersey City, NJ (US)

(72) Inventors: Ryan T. Shearman, Jersey City, NJ (US); Todd H. Rushing, Hackensack, NJ (US); Steven L. Smith, Putnam Valley, NY (US)

(21) Appl. No.: 15/443,596

(22) Filed: Feb. 27, 2017

Related U.S. Application Data
(60) Provisional application No. 62/300,680, filed on Feb. 26, 2016.

(51) Int. Cl. G02B 27/01; A42B 3/22; H04N 9/31; G02B 27/14; A42B 3/06; A42B 3/04

(52) U.S. Cl. CPC G02B 27/0172; A42B 3/061; A42B 3/222; G02B 27/0149; H04N 9/3141; A42B 3/0426; G02B 27/142; G02B 2027/0138; G02B 2027/0141; G02B 2027/0194; G02B 2027/0114

(57) ABSTRACT

One variation of a system for serving augmented visual content to a user includes: a visor including a substrate of a transparent material and a reflective coating applied across the substrate, configured to selectively reflect visible light within a first reflection channel, and configured to transmit wavelengths of visible light outside of the first reflection channel, wherein the first reflection channel spans a first band of wavelengths; a projection system configured to project visual content in a first output channel onto an interior surface of the visor, the first output channel including a first peak-power wavelength of visible light within the first reflection channel and excluding wavelengths of visible light outside the first reflection channel; and a support structure configured to locate the visor on the user's head with the visor in a field of view of the user and configured to locate the projection system relative to the visor.

### CROSS-REFERENCE TO RELATED APPLICATIONS

This application claims the benefit of U.S. Provisional Application No. 62/300,680, filed on 26 Feb. 2016, which is incorporated in its entirety by this reference.

This application is related to U.S. patent application Ser. No. 14/821,426, filed on 7 Aug. 2015, which is incorporated in its entirety by this reference.

### TECHNICAL FIELD

This invention relates generally to the field of heads-up displays and more specifically to a new and useful method and notch reflector projection system in the field of heads-up displays.

### BRIEF DESCRIPTION OF THE FIGURES

FIGS. 1A and 1B are schematic representations of a system;

FIGS. 2A and 2B are a schematic representations of one variation of the system; and

FIG. 3 is a graphical representation of one variation of the system; and

FIG. 4 is a schematic representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System and Method

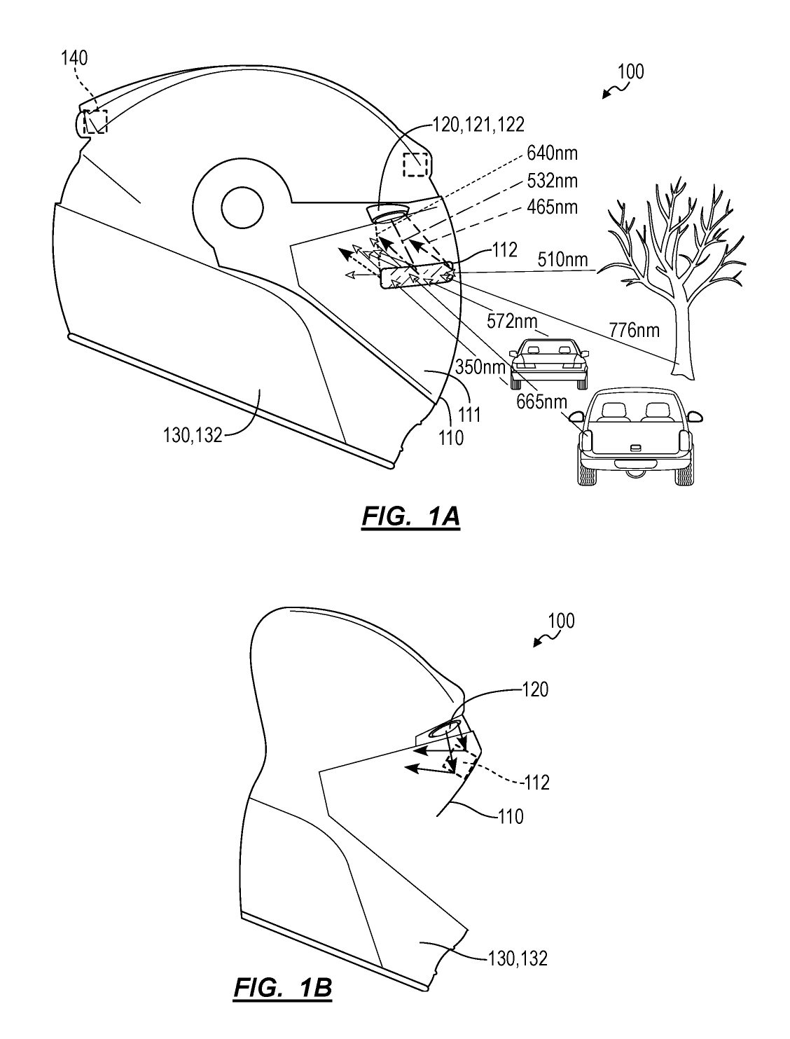

As shown in FIGS. 1A and 1B, a system 100 for serving augmented visual content to a user includes: a visor 110; a projection system 120; and a support structure 130. The visor 110 includes: a substrate 111 including a transparent material; and a reflective coating 112 applied across the substrate 111, configured to selectively reflect visible light within a first reflection channel, and configured to transmit wavelengths of visible light outside of the first reflection channel, wherein the first reflection channel spans a first narrow band of wavelengths. The projection system 120 is configured to project visual content in a first output channel onto an interior surface of the visor 110, wherein the first output channel includes a first peak-power wavelength of visible light within the first reflection channel and excludes wavelengths of visible light outside the first reflection channel. The support structure 130 is configured to locate the visor 110 on a head of the user with the visor 110 in a field of view of the user and configured to locate the projection system 120 relative to the visor 110.

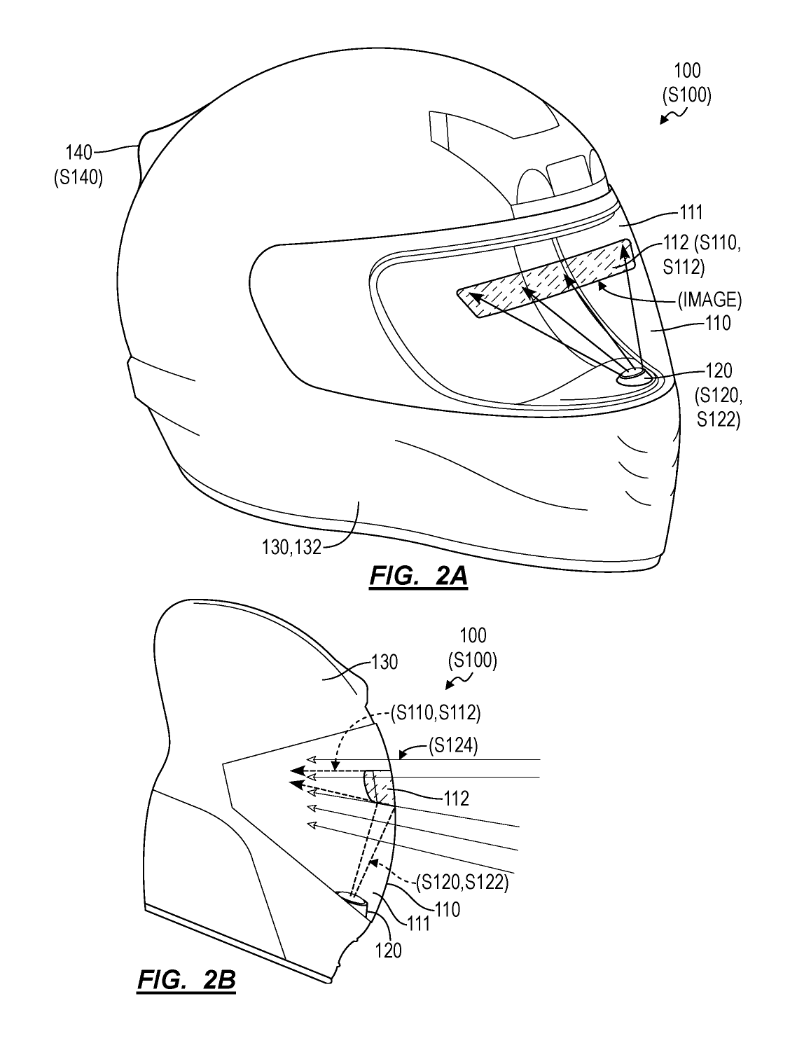

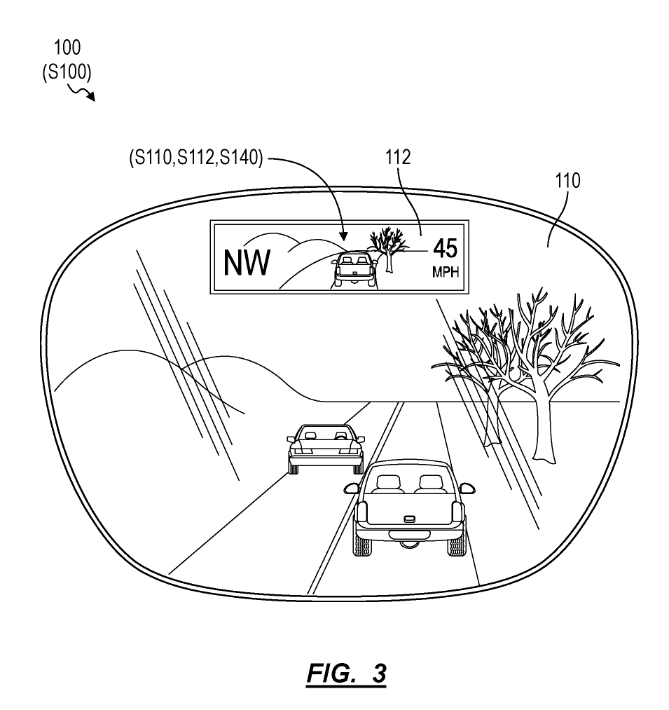

As shown in FIGS. 2A and 3, one variation of the system 100 includes: a helmet 132; a camera 140; a visor 110; and a projection system 120. The helmet 132 defines an interior volume and an aperture proximal an anterior end of the helmet 132. The camera 140 is coupled to the helmet 132 and is configured to output a sequence of video frames of a field extending outwardly from a posterior end of the helmet 132. The visor 110 is arranged across the aperture and includes: a substrate 111 including a transparent material; and a reflective coating 112 applied across the substrate 111 and configured to reflect a first narrow band of visible light, to reflect a second narrow band of visible light distinct from the first narrow band of visible light, and to transmit wavelengths of visible light outside of the first narrow band of visible light and the second narrow band of visible light. The projection system 120 is arranged within the helmet 132 and is configured to project a sequence of composite images including a first light component at a wavelength within the first narrow band of visible light and a second light component at a wavelength within the second narrow band of visible light onto an interior surface of the visor 110, wherein the sequence of composite images represents a sequence of video frames output by the camera 140.

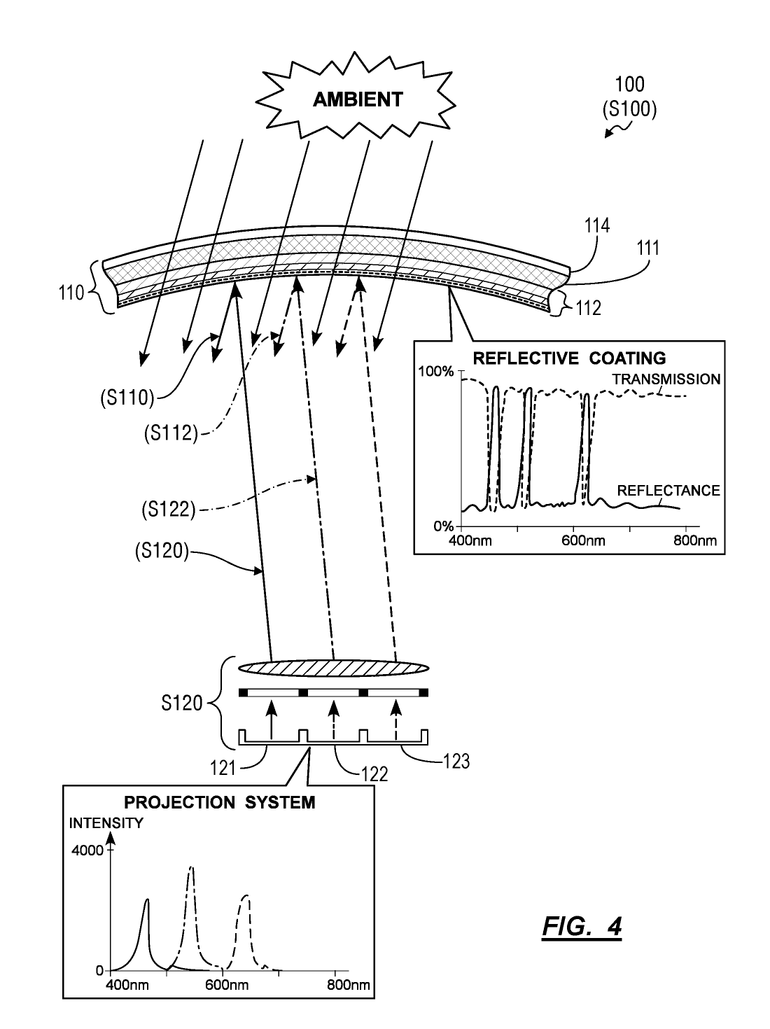

As shown in FIGS. 1 and 4, another variation of the system 100 includes: a visor 110; a projection system 120; and a reflective coating 112. The visor 110 is arranged across the aperture and includes a transparent material; the projection system 120 is configured to project visible light within a first output channel and within a second output channel, in the form of a composite color image, onto the visor 110, wherein the first output channel spans a first band of wavelengths of visible light and the second output channel spans a second band of wavelengths of visible light distinct and offset from the first band of wavelengths of visible light. The reflective coating 112 is applied across the visor 110 and configured: to selectively reflect wavelengths of incident visible light, incident within a first reflection channel overlapping the first output channel; to selectively reflect wavelengths of incident visible light within a second reflection channel overlapping the second output channel, the second reflection channel distinct and offset from the first reflection channel; and to transmit wavelengths of visible light outside of the first reflection channel and the second reflection channel.

As shown in FIGS. 2B an 3, the system can execute a method S100, including: at a projection system 120, projecting visible light within a first band of output wavelengths onto a visor 110 in Block S120, the first band of output wavelengths corresponding to a first color component; at the projection system 120, projecting visible light within a second band of output wavelengths onto the visor 110 in Block S122, the second band of output wavelengths corresponding to a second color component and distinct and offset from the first band of output wavelengths; at a visor 110 reflecting incident visible light within a first band of reflection wavelengths in Block S110, the first band of reflection wavelengths overlapping the first band of output wavelengths; at the visor 110, reflecting incident visible light within a second band of reflection wavelengths in Block S112, the second band of reflection wavelengths overlapping the second band of output wavelengths and distinct and offset from the first band of reflection wavelengths; and, at the visor 110 transmitting visible light outside of the first band of reflection wavelengths and outside of the second band of reflection wavelengths in Block S124.

### 2. Applications

Generally, the system 100 includes: a projector that outputs light in a limited number of discrete, narrow bands of electromagnetic radiation in the visible spectrum; a visor 110 that exhibits both high reflectivity at wavelengths within the discrete, narrow bands and high transmission at wavelengths in the remainder of the visible spectrum; and a helmet 132 that supports both the projection system 120 and the visor 110. For example, the projection system 120 can project single-color images (i.e., images at a single wavelength or within a narrow band of wavelengths in the visible spectrum), such as overlay images including textual and/or graphical driving directions onto the interior surface of the visor 110, and the visor 110 can reflect these single-color images toward an interior region of the helmet 132 where a user's eyes may fall when wearing the system 100. The system 100 can also include a rear-facing camera 140 that captures video frames of a field behind the helmet 132; for each video frame captured by the rear-facing camera 140, the projection system 120 can project multiple single-color images (e.g., a red component image at 624 nanometers, a green component image at 522 nanometers, and a blue component image at 465 nm) that, when reflected by the visor 110, combine to form a (near-) full-color image representative of the video frame captured by the rear-facing camera 140, as shown in FIG. 3. The user can view these single-color overlay images and/or (near-) full-color images by directing his gaze through the plane of the visor 110, which includes narrow band reflective coatings (e.g., a notched dielectric coating) that reflects light output from the projection system 120 toward the user's eyes. However, the visor 110 is substantially transparent to wavelengths of light within a significant remainder of the visible spectrum and thus allows ambient light to pass through the visor 110, as shown in FIGS. 1A and 1B, such that the user can also view surfaces in a field ahead (e.g., with minimal color distortion) by focusing his gaze beyond the visor 110.

The projection system 120 can therefore project rearview-mirror-like content, telemetry and systems data, and/or navigation data, etc. in a limited number of (e.g., three) discrete, narrow (e.g., 20-nanometer-wide) bands of visible light onto the interior surface of the visor 110, and the visor 110 can selectively reflect these discrete bands of visible light toward the interior volume of the helmet 132 for visual consumption by the user. However, because the visor 110 is selectively opaque to only these discrete bands of visible light, the visor 110 can appear to the user as (nearly-) transparent across the visible spectrum, thereby enabling the user to view both content projected on the visor 110 and the field ahead of the visor 110.

The projection system 120 and visor 110 are described herein as integrated into a helmet 132—such as a motorcycle helmet 132, an all-terrain-vehicle helmet 132, an automobile racing helmet 132, a skiing helmet 132, a snowboarding helmet 132, a snowmobile helmet 132, a bicycle helmet 132, a firefighting helmet 132, or a disaster-relief helmet 132—to form a “helmet 132 system.” However, the projection system 120 and a selectively-reflective panel (e.g., the visor 110) can be integrated into any other system—such as into the windshield of a vehicle or into a window in a residential or commercial structure—to achieve both high-visibility through the panel and high-visibility of an image projected onto the panel. The projection system 120 and a selectively-reflective panel (e.g., the visor 110 and coating) can also be integrated into other systems, such as a wearable goggle, to achieve both high-visibility through the panel and high-visibility of an image projected onto the interior surface of the panel.

### 3. Support Structure

The support structure 130 is configured to locate the visor 110 on a user's head with the visor 110 in a field of view of the user and configured to locate the projection system 120 relative to the visor 110.

As described in U.S. patent application Ser. No. 14/821,426, the support structure 130 can include a helmet 132 that defines an interior volume and an aperture proximal an anterior end of the helmet 132. In this variation, the helmet 132 can function to support the visor 110, the projection system 120, one or more cameras, and/or other components within the system 100 and to provide head and/or face protection for the user in the event of an impact, such as while riding a motorcycle or skiing.

The helmet 132 can define a full-face helmet 132 including an interior volume termination at a head opening to receive a user's head and a viewing aperture through which the user may look outwardly from the helmet 132 during use, wherein the head opening and the viewing aperture are separated by a chin bar. Alternatively, the helmet 132 can define a three-quarter helmet 132 that similarly covers the back of the user's head and ears when worn but excludes a chin bar. Yet alternatively, the helmet 132 can define a half helmet 132. However, the helmet 132 can define a helmet 132 of any other suitable type or geometry.

In one variation, the system 100 also includes one or more cameras, such as a rear-facing CCD or CMOS camera. For example, during operation, the rear-facing camera 140 can capture color video frames, and the projection system 120 can project a form of these video frames (e.g., resealed or trimmed versions of these video frames) onto the visor 110 substantially in real-time to provide the user with a view of the field behind him. For example, the camera 140 can record a color image of a field extending outwardly from a posterior end of the helmet 132 in Block S140, wherein the color image includes a first color channel and a second color channel, etc. The projection system 120 can then project a form of this image onto the visor 110 in Blocks S120 and S122, and the visor 110 can reflect visible light representing the form of the image into the eyes of a user in Blocks S110 and S112 while also passing ambient light to the user's eyes in Block S124. In this example, the camera 140 can record color components of an image in discrete wavelength bands (e.g., red, green, and blue color component wavelengths) substantially matched to the output channels of the projection system 120 and the reflection channels of the visor 110. Alternatively, the camera 140 can record color components of an image in discrete wavelength bands differing from output channels of the projection system 120; in this implementation, the projection system 120 can transform color components of the original image recorded by the camera 140 into color components matched to the output channels of the projection system 120 and the reflection channels of the visor 110, such as according to a predefined transform matrix or color intensity value shift for each color component of the original image, before projecting a form of the image onto the visor 110 in Blocks S120 and S122.

In this variation, the system 100 can also augment video frames output by the camera 140 with additional textual and/or graphical content, such as rearview-mirror-like content, telemetry and systems data, and/or navigation data, before these augmented video frames are projected onto the visor 110.

Though described below as defining a helmet 132, the support structure 130 can define any other structure or form. For example, the support structure 130 can define a pair of glasses; in this example, the support structure 130 can cooperate with the visor 110 and the projection system 120 to form an augmented reality headset with an eyes-up display in which content is projected directly onto the visor 110 and in which the reflective coating 112 selectively reflects wavelength of light output by the projection system 120 into a user's eyes. In another example, the support structure 130 can define a mask, such as a firefighting mask; in this example, the support structure 130 can cooperate with the visor 110 and the projection system 120 to form an augmented reality mask containing an eyes-up display in which the visor 110 both functions as a face shield and selectively reflects wavelength of light output by the projection system 120 into a user's eyes.

### 4. Visor

As shown in FIG. 4, the visor 110 is arranged across the aperture and includes: a substrate 111 including a transparent material; and a reflective coating 112 applied across the substrate 111 (e.g., across the interior surface of the substrate 111 facing the interior of the helmet 132), configured to reflect a narrow band of visible light, and configured to transmit wavelengths of visible light outside of the narrow band of visible light. Generally, the visor 110 is highly-transparent across the visible spectrum except for a limited number of (e.g., three) discrete, narrow bands in the visible spectrum for which the visor 110 is highly-reflective.

In one implementation, the visor 110 defines a primary visor 110 configured to close the aperture. In this implementation, the visor 110 can be rigidly coupled to the helmet 132 over the aperture. Alternatively, the visor 110 can be pivotably coupled to the helmet 132 and can be opened and closed over the aperture. In this implementation, because wavelengths of light reflected by the reflective coating 112 may be a function of the linear and angular offset between the visor 110 and the projection system 120, the projection system 120 can be fixed coupled to the visor 110 in order to preserve overlap between an output channel (i.e., a narrow band of wavelengths of visible light output by the projection system 120) and a corresponding reflection channel (i.e., a narrow band of wavelengths of visible light reflected by the reflective coating 112 on the visor 110).

In another implementation, the visor 110 defines a secondary visor 110 offset behind a primary visor 110, as described in U.S. patent application Ser. No. 14/821,426. For example, the visor 110 can be suspended from the interior of the helmet 132 and supported by a beam between the primary visor 110 and a region within the system 100 coincident a user's eyes when the system 100 is worn.

### 4.1 Visor Substrate

The visor 110 includes a substrate 111 that is generally transparent across the visible spectrum. In one example in which the visor 110 defines a primary visor 110, the visor 110 includes a 4.0-millimeter polycarbonate substrate 111 exhibiting at least 92% transmission of light between 400 nm and 800 nm at angles of incidence less than 70°. In another example in which the visor 110 defines a secondary visor 110, the visor 110 includes a 1.5-mm-thick polymer, co-polymer, or injection-moldable transparent substrate 111 of any other material substrate 111 exhibiting at least 90% transmission of incident light between 300 nm and 1000 nm at angles of incidence less than 80°. However, the visor 110 can include a substrate 111 of any other suitable material and/or thickness.

The visor substrate 111 can define a substantially planar interior surface facing the interior of the helmet 132, such as for the visor 110 that defines a second visor 110 arranged behind a primary visor 110. Alternatively, the visor substrate 111 can define an interior surface that is curvilinear in two or three dimensions, such as for the visor 110 that defines a primary visor 110 arranged over an aperture in the helmet 132. However, the visor substrate 111 can define any other suitable geometry.

### 4.2 Reflective Coating

The visor 110 also includes reflective coating 112 that is highly selectively reflective to electromagnetic radiation within one or more narrow bands in the visible spectrum and that is highly-transparent to substantially all other wavelengths in the visible spectrum, as shown in FIG. 4. Generally, the reflective coating 112 can be particularly reflective (e.g., at least 75% reflective) across a set of discrete wavelength bands (e.g., 20-nanometer-wide full-width half-max bands) in the visible spectrum, each band including a specific centered target wavelength (e.g., one of 640 nm, 522 nm, and 465 nm) matched to output channels of the projection system 120; and the reflective coating 112 can exhibit high transparency (e.g., at least 90% light transmission) to other wavelengths of light in the visible spectrum.

For each target wavelength output by the projection system 120 (hereinafter “output channel”), the reflective coating 112 can exhibit high reflectivity to wavelengths across a narrow wavelength band of a target width (hereinafter “reflection channel”) in order to compensate for variations in the actual wavelength output by the projection system 120 during operation of the system 100. For example, the center wavelength in a reflection channel can correspond to the peak-power wavelength (or “primary wavelength”) output by the projection system 120 for the corresponding output channel when the projection system 120 is at a standard operating temperature (e.g., 120° F.). In this example, because the actual output wavelength of an output channel in the projection system 120 may change as a function of temperature, the width of the reflection channel can be sufficient to reflect at least a minimum percentage (e.g., 78%) of light output by the projection system 120 for the corresponding output channel across the full operating temperature range of the system 100 (e.g., from 30° F. to 150° F.).

Each reflection channel characterizing the reflective coating 112 can therefore reflect a narrow band of visible light—rather than a single wavelength of visible light—in order to compensate for output wavelength drift due to temperature fluctuations in the corresponding output channel of the projection system 120. Each reflection channel of the reflective coating 112 can also be configured to reflect a narrow band of visible light in order to compensate for manufacturing tolerances of a light source in the corresponding output channel. Furthermore, the reflective coating 112 may reflect select wavelengths of light as a function of angle of incidence; each reflection channel can therefore reflect a bandwidth of light sufficient to compensate for variations in angle of incidence of light output from the corresponding output channel and incident on the visor 110. In one example in which the interior surface of the visor 110 is curvilinear in one or two planes, light rays output by the projection system 120 may reach the interior surface of the visor 110 across a range of incidence angles. The bandwidth of each reflection channel in the reflective coating 112 on the visor 110 can therefore be sufficiently wide to reflect light output from the corresponding output channel and incident on the visor 110 across the range of incidence angles.

In one example, the reflective coating 112 is configured to reflect visible light within a first reflection channel defining a full-width half-maximum reflection wavelength band less than twenty nanometers in width; and a first light source 121 in the projection system 120 is configured to output visible light within a corresponding first output channel defining a full-width half-maximum output wavelength band less than twenty nanometers in width, wherein the full-width half-maximum output wavelength band overlaps the full-width half-maximum reflection wavelength band. In this example, the first light source 121 in the projection system 120 can include a light-emitting diode (“LED”) exhibiting a full-width half-maximum output wavelength band approximately sixteen nanometers in width and fully or substantially overlapping the full-width half-maximum reflection wavelength band of the first reflection channel at a standard operating temperature of the projection system 120.

The visor 110 and the projection system 120 can also form a substantially rigid imaging subassembly in which the angle of the visor 110 to the projection system 120 is fixed, and the imaging subassembly can be pivotable about a lateral axis of the helmet 132 (e.g., parallel to the user's frontal axis when looking forward) across a limited arcuate range (e.g., ±15°) such that the user may adjust the visor 110 to reflect light into his eyes.

As described above, the narrow band of visible light reflected by a reflection channel in the reflective coating 112 can include a primary wavelength output by the corresponding output channel in the projection system 120. Alternatively, the reflective coating 112 can reflect light in discrete reflective channels that exclude the primary wavelength output by the corresponding output channel in the projection system 120. For example, the projection system 120 can project light onto the visor 110 at a non-normal angle to the interior surface of the visor 110. Because wavelengths of light reflected by the reflective coating 112 may be a function of angle of incidence of light on the visor 110, the reflection channels characterizing the reflective coating 112 can be tuned to reflect the primary wavelengths output by corresponding output channels in the projection system 120 for the angle of incidence of this light on the interior surface of the visor 110. In this example, if a first output channel in the projection system 120 outputs light at a primary wavelength of 640 nm, the projection system 120 can project light onto the visor 110 at angles of incidence between 20° and 22°, and the first reflection channel of the reflective coating 112 can exhibit a high selectivity for 640 nm light across the incidence angle range such that at least 80% of projected light between 630 nm and 640 nm is reflected by the reflection channel on the visor 110 and such that at least 80% of light outside of this band is not reflected by the first reflection channel

However, the reflective coating 112 can support any other number of reflection channels reflecting narrow bands of visible light over any other width or center wavelength.

### 4.3 Reflection Channel Wavelength Band Selection

In one implementation, the reflective coating 112 is configured to reflect select wavelengths of light distinct from (i.e., not overlapping) wavelengths of light commonly output by traffic signals (e.g., stop lights, metering lights) in a city, state, region, country, continent, or other geographic region in which the system 100 is sold is designated for operation or otherwise occupies. For example, for the system 100 designated for sale in a country or region with traffic lights that output primary red wavelengths between 650 nm and 695 nm, primary yellow wavelengths between 610 nm and 630 nm, and primary green wavelengths between 530 nm and 565 nm, the visor 110 can exhibit relatively high light transmission (e.g., greater than 70%) across wavelength bands from 650 nm to 695 nm, from 610 nm to 630 nm, and from 530 nm to 565 nm at viewing angles from 0° to 70° such that light output by stop lights in this region may pass through the visor 110. In particular, the visor 110 can be configured to pass select wavelengths of light output by traffic lights such that the user may read these traffic lights when wearing the system 100. In this example: the reflective coating 112 can reflect three discrete, narrow bands of visible light, such as a first band from 635 nm to 645 nm, a second band from 525 nm to 545 nm, and a third band from 455 nm to 475; and the projection system 120 can project light at primary wavelengths of 640 nm, 532 nm, and 465 nm according to an additive color model so as to exclude wavelengths of light output by traffic signals, as described below.

The visor 110 can similarly be configured to pass primary wavelengths of visible light: actively output by brakes lights and blinkers of vehicles; passively reflected or actively output by regulatory signs (e.g., red “STOP,” “WRONG WAY,” and “YIELD” signs); passively reflected or actively output by traffic warning signs (e.g., yellow serpentine road or sharp-turn signs); and/or passively reflected or actively output by guide signs (e.g., green route designation and distance signs, blue recreational and point of interest signs); etc. in the region in which the system 100 is sold.

The visor 110 can thus be configured to reflect one or more discrete, narrow bands of visible light substantially excluding primary wavelengths of most or all of the foregoing motor-vehicle-related signage and lighting systems. In particular, by exhibiting high transparency to (e.g., at least 70% power transmission of) wavelengths of light commonly passively reflected by and/or actively output by to motor vehicles and related signage, the system can enable a user to visually discern such content originating outside of the system and augmented reality content output by the internal projection system 120, such as while riding a motorcycle and wearing a helmet outfitted with the system.

### 4.4 Visor Manufacture

In one implementation, the visor substrate 111 is manufactured in polycarbonate by injection molding, is treated with a hard coat, trimmed to size, and then polished. The visor substrate 111 is then placed in a vacuum deposition chamber; quartz and metal oxides are vaporized with an electron beam gun and condensed in thin (e.g., micron-thick) stacked layers on the interior surface of the visor substrate 111. The layers of quartz and metal oxides are deposited on the interior surface of the visor substrate 111 in alternating layers of controlled thicknesses tuned such that the stack of layers form a reflective crystalline coating that exhibits high reflectivity (e.g., >50% reflectivity) to electromagnetic radiation in discrete, narrow bands within the visible spectrum and high optical transparency to (e.g., >50% transmission of) other wavelengths in the visible spectrum. In this implementation, an olio-phobic, an anti-fog coating, and/or a scratch-resistant hard-coat 114 can then be applied to the outside the visor substrate 111.

In another implementation, a first planar sheet of cast or extruded polycarbonate is heated and drawn over a three-dimensional buck (e.g., in a vacuum forming machine) into a three-dimensional structure. The interior and exterior surfaces of the assembly are then polished, and the outside (e.g., the convex surface) of the structure is then hard-coated. The inside (e.g., the concave surface) of the structure is then coated with a notched dielectric coating, as described above, to complete the visor 110. However, the visor 110 can be manufactured in any other suitable way.

### 5. Projection System

The projection system is configured to project visual content (e.g., dynamic telemetry data, map data, or a video feed from a rear-facing camera 140) in a first output channel onto an interior surface of the visor 110, wherein the first output channel includes a first peak-power wavelength of visible light within a first reflection channel of the visor 110 and excludes wavelengths of visible light outside the first reflection channel. Similarly, the projection system 120 can be configured to project visible light within a first output channel and within a second output channel—in the form of a composite color image—onto the visor 110, wherein the first output channel spans a first band of wavelengths of visible light and wherein the second output channel spans a second band of wavelengths of visible light distinct and offset from the first band of wavelengths of visible light.

Generally, the projection system 120 outputs one more narrow bands of visible light that fall within or overlap narrow bands of visible light reflected by the visor 110. For example, for each video frame captured by the camera 140, the projection system 120 can: generate three discrete single-wavelength (or narrow wavelength band) images, such as a red image at 640 nm, a green image at 522 nm, and a blue image at 465 nm; combine the three single-wavelength images into a single composite image representative of the video frame; and project the composite image onto the visor 110. Because the projection system 120 outputs wavelengths of light are substantially matched to wavelengths of light reflected by visor 110, a large proportion (e.g., >80%) of light output by the projection system 120 is reflected back toward the user wherein it is perceived by the user as a color-true (or near-color-true) image. However, because the visor 110 selectively reflects these narrow bands of visible light but transmits a large proportion (e.g., >80%) of substantially all other wavelengths of light in the visible spectrum, ambient light—outside of these narrow bands—incident on the visor 110 can pass through the visor 110 and reach the user's eyes, thereby enabling the user to also view the field ahead of him with minimal color distortion. For example, by directing his gaze through the reflective coating 112 on the visor 110, the user may view both virtual content projected onto the visor 110 in (near-) full-color and real objects in the field ahead of the user in (near-) full-color. The user may therefore consume both projected virtual content and real objects in his field of view in (near) full-color by directing his gaze through the visor 110 and without refocusing his gaze on either the visor 110 or the field ahead.

### 5.1 Narrow-Band Light Sources

In one implementation shown in FIG. 4, for each discrete, narrow band of visible light reflected by the visor 110 (or “reflection channel”), the projection system 120 includes: a light source configured to output a narrow band of visible light (or “output channel”) within or overlapping the corresponding reflection channel; and a liquid-crystal display (LCD) unit that defines an array of pixels that selectively pass light from the light source toward the visor 110.

In one example, the visor 110 is configured to reflect three discrete bands of visible light, including a first (red) band from 620 nm to 640 nm, a second (green) band from 522 nm to 542 nm, and a third (blue) band from 455 to 475 nm (when operating at room temperature). In this example, the projection system 120 can include: a red LED configured to output a narrow band of visible light centered at 630 nm when at operating temperature; a green LED configured to output a narrow band of visible light centered at 522 nm when at operating temperature; and a blue LED configured to output a narrow band of visible light centered at 465 nm when at operating temperature. In this example, the projection system 120 can also include: one LCD unit paired with each of the red, green, and blue LEDs, such as in the form of an LCD display chip that includes red, green and blue transmissive sub-pixels; and an optical subsystem that recombines light transmitted by each of the LCD units into one composite image and projects this composite image onto the visor 110.

Generally, in this implementation, the projection system 120 includes multiple light sources that each output light at a discrete wavelength (or in a discrete, narrow wavelength band) corresponding to a wavelength (or narrow wavelength band) of visible light reflected by the visor 110, and the projection system 120 implements an additive color model to reproduce a broad array of colors in an image reflected from the visor 110 into the user's eyes with only a limited number of (e.g., three) discrete wavelengths (or narrow wavelength bands) represented by light sources in the projection system 120. Therefore, because substantially all light output by the light source(s) is reflected toward the user's eyes, the projection system 120 and the visor 110 can cooperate to achieve relatively high output power efficiency and minimal waste light (e.g., light output by the projection system 120 and transmitted through rather than reflected by the visor 110).

In this implementation, rather than LEDs, the projection system 120 can alternatively include one laser diode (or laser diode array) per output channel, wherein each laser diode (or laser diode array) is similarly selected for an output wavelength of visible light within or centered within the corresponding band of visible light reflected by the visor 110 (e.g., at a target operating temperature). However, the projection system 120 can include one or more light sources of any other type.

Therefore, in this implementation, the projection system 120 can include: a first light source 121 configured to output visible light within a first output channel overlapping the first reflection channel of the reflective coating 112; a second light source 122 configured to output visible light within a second output channel overlapping the second reflection channel of the reflective coating 112. (The projection system 120 can similarly include a third light source 123, as shown in FIG. 4.) The projection system 120 can thus project—onto the visor 110—visible light within the first output channel that includes a first peak-power wavelength that falls within the corresponding first reflection channel of the visor 110 and that excludes wavelengths of visible light substantially outside the first reflection channel. Similarly, the projection system 120 can project—onto the visor 110—visible light within the second output channel that includes a second peak-power wavelength that falls within the second reflection channel of the visor 110 and that excludes wavelengths of visible light substantially outside the second reflection channel.

### 5.2 Wide-Band Light Sources

In one implementation, the projection system 120 includes a set of broadband illuminators, including one broadband illuminator paired with each reflection channel in the visor 110 coating, and one LCD per broadband illuminator. In this implementation, each broadband illuminator can output light over a relatively wide range of wavelengths, such as over a 40-nanometer-wide band. However, each reflection channel can reflect a relatively narrow band of light, such as a 5-nanometer-wide band, within the wider band of light output by its corresponding broadband illuminator. Therefore, as the output of a broadband illuminator varies during operation due to temperature changes, an overlap between wavelengths of light output by the broadband illuminator and wavelengths of light reflected by the corresponding reflection channel on the visor 110 can persist. For example, a reflection channel can be configured to reflect a relatively narrow band of light (that is, the reflection channel is highly selective to a relatively narrow band of light) substantially centered within a relatively wide band of light output by the corresponding broadband illuminator at a typical operating temperature of 100° F., and the broadband illuminator can output a band of light of width slightly greater than a shift in center output wavelength of the broadband illuminator over an operating temperature range from 0° F. to 200° F.

### 5.3 White-Light Light Source

In another implementation, the projection system 120 includes: a single white-light light source; an LCD unit; and a reflective filter element interposed between the white-light lamp and the LCD unit and including a reflective coating 112 substantially identical to the reflective coating 112 on the visor 110, configured to transmit wavelengths of light substantially identical to wavelengths of light transmitted by the reflective coating 112 on the visor 110, and configured to reflect wavelengths of light—substantially identical to wavelengths of light reflective by the reflective coating 112 on the visor 110—into the LCD unit. Alternatively, in this implementation, the projection system 120 can include a subtractive filter in place of the reflective filter, wherein wavelengths subtracted by the subtractive filter fall outside of wavelengths reflected by the reflective coating 112 on the visor 110.

Yet alternatively, in this implementation, the projection system 120 can exclude a subtractive filter and/or a reflective filter and can instead project substantially all wavelengths from the illumination system onto the reflective coating 112 on the visor 110, and the reflective coating 112 on the visor 110 can “subtract” (e.g., pass) select wavelengths through the visor 110 rather than reflect these wavelengths back toward the user's eyes.

In this implementation, the projection system 120 includes an optical element substantially similar (i.e., optically matched) to the visor 110 such that substantially all light output by the projection system 120 will fall within one or more narrow wavelengths bands reflected by the visor 110. Optical performance of the system 100 (i.e., transmission of ambient light and reflection of light output by the projection system 120) can be isolated from the light source and therefore from variations in power output of the light source across the visible spectrum due to manufacturing tolerances and changes in temperature within the projection system 120.

For the visor 110 that reflects three discrete bands of visible light (e.g., red, green, and blue light), the projection system 120 can include: a white-light light source; a single reflective filter element exhibiting optical properties substantially similar to the visor 110 and reflecting three discrete bands of visible light substantially identical to the three discrete bands of visible light reflected by the visor 110; a trichroic prism that splits light reflected by the single reflective filter element into three discrete light beams (e.g., a red beam, a green beam, and a blue beam); three LCD units, each LCD receiving a single light beam from the trichroic prism; and an optical subsystem that recombines beams of light transmitted by each of the LCDs unit into one composite image and projects the composite image toward the visor 110.

In this implementation, the reflective filter element can be manufactured according to the same manufacturing process as the visor 110. For example, the reflective filter element can include a polycarbonate substrate 111 that is hard-coated, as described above. In this example, the visor substrate 111 and the reflective filter element can be cast in-unit, separated, and then treated together with a notch-reflective coating 112, an olio-phobic coating, an anti-fog coating, and/or an anti-scratch coating, etc. After coating, the visor 110 and reflective filter element can be installed in their corresponding positions within the system 100. In this example, the visor 110 with reflective coating 112 and the filter element with reflective coating 112 can therefore be optically matched regardless of variations in substrate 111 material and coating properties across manufacturing batches.

Alternatively, in this implementation, the projection system 120 can include a color wheel arranged between the white-light light source and a single LCD. In this configuration, the color wheel can include a set of reflective filter elements, wherein each reflective filter element reflecting a discrete wavelength (or narrow band) of visible light. In one example: the color wheel includes three reflective filter elements, such as a first reflective filter element configured to reflect a target wavelength of 640 nm, a second reflective filter element configured to reflect a target wavelength of 522 nm, and a third reflective filter element configured to reflect a target wavelength of 465 nm; the projection system 120 also includes a rotary actuator that rotates the color wheel rotates at an angular speed three times the frame rate of the system 100; and the LCD refreshes once per supported color for each frame projected onto the visor 110 based on the position of the color wheel. However, in this implementation, the projection system 120 can include any other combination of white-light sources and reflective filter elements.

### 5.4 Configurations

In one configuration, the helmet 132 includes a single projection system 120 configured to project a single wide (e.g., “widescreen”) image onto the visor 110. Alternatively, the helmet 132 includes a single projection system 120 configured to project a left image and a right image onto the visor 110. In one example of this configuration, the projection system 120 includes one or more light sources and LCD units that cooperate to simultaneously output a left image and an adjacent right image in a single frame, and the optical subsystem within the projection system 120 includes a mirror optical splitter than projects the left image onto a left target projection region on the visor 110 and projects the right image onto the right target projection region on the visor 110. In another example of this configuration: the optical subsystem within the projection system 120 includes a mirror that oscillates between a left position and a right position at a rate equivalent to twice a frame rate of the projection system 120; the LCD unit outputs a left image of a particular frame when the mirror is in the left position; and the LCD unit outputs a right image of the particular frame when the mirror is in the right position. Yet alternatively, the system 100 can include two independent projection systems, including a left projection system 120 that projects a left image onto a left target projection region on the visor 110 and including a right projection system 120 that projects a right image onto a right target projection region on the visor 110.

The projection system(s) can be arranged above the visor 110, such as between interior and exterior shells of the helmet 132, and the projection system(s) can project images downward and/or forward onto the visor 110, as shown in FIGS. 1A and 1B. Alternatively, the projection system(s) can be arranged in a chin guard within the system 100 and can project images upward onto the visor 110, as shown in FIGS. 2A and 2B. Yet alternatively, the system 100 can include one projection system 120 at each temple region, wherein each projection system 120 is configured to project images inward toward the visor 110. However, the system 100 can include any other number of projection systems arranged in any other suitable configuration.

### 6. Overlay Reflection and Output Channels

In one variation, in addition to reflection channels corresponding to colors in an additive color model implemented by the projection system 120, the visor 110 also supports an overlay reflection channel, and the projection system 120 similarly outputs light in an overlay output channel. In this variation: in addition to reflecting wavelengths of visible light in an additive color model (e.g., an RGB model), the visor 110 also reflects a narrow band of visible light in the overlay reflection channel; and the projection system 120 supports an overlay output channel that outputs an additional overlay image at a primary wavelength within the overlay reflection channel, combines this overlay image with images output by the additive color output channels (described above), and projects this composite image (e.g., a four-channel image for the projection system 120 that includes RGB output channels) toward the visor 110.

In one example, the system 100 includes a rear-facing camera 140 that detects light intensities at 640 nm (red), 522 nm (green), and 465 nm (blue) at each pixel within a pixel grid. During operation, the rear-facing camera 140 captures video frames (e.g., photographic images) in RGB-composite format. In this example, the projection system 120 supports 640 nm, 522 nm, and 465 nm output channels and projects video frames captured by the rear-facing camera 140 onto the visor 110 substantially in real-time. In this example, the visor 110 is configured to reflect narrow bands of visible light in reflection channels corresponding to (e.g., centered at) each of 640 nm, 522 nm, and 465 nm. The user can thus perceive light reflected by the visor 110 as a color-true (or near-color-true) image of a field behind the user, as described in U.S. patent application Ser. No. 14/821,426.

However, in the foregoing example, the projection system 120 can also include a 595 nm (orange) overlay output channel, and the visor 110 can similarly reflect a narrow band of visible light in an overlay reflection channel corresponding to (e.g., centered at) 595 nm. During operation, a processor within the helmet 132 can generate single-color overlay images including textual and graphical directions, warnings, prompts, road conditions, emergency data, etc., and the projection system 120 can project these overlay images onto the visor 110 through the 595 nm overlay output channel. The visor 110 reflects both the overlay image and the RGB-composite video frame in the RGB output channels toward the user's eyes. The user may then perceive light reflected by the visor 110 as a color-true (or near-color-true) image of the field behind the user with an orange overlay of text and/or graphics.

In this variation, the overlay output channel in the projection system 120 can be dedicated to overlay content and can be independent of other color output channels implementing an additive color model within the projection system 120. Overlay content output by the projection system 120 and reflected by the visor 110 can therefore appear relatively bright and/or in high-contrast relative to color video content projected onto the visor 110 by the projection system 120.

### 7. Variations

In one variation, the projection system 120 and visor 110 are implemented as a projector and a windscreen, respectively, in a motor vehicle (e.g., a passenger car or SUV, a commercial truck). In this variation, the windscreen can include: a transparent glass or polymer substrate 111; and a reflective coating 112 applied over the substrate 111 (e.g., across the interior surface of the windscreen) and configured to reflect select narrow bands of visible light in one or more reflection channels, as described above. The projector can thus project light—in one output channel per reflection channel—directly onto the windscreen. The windscreen can thus selectively reflect light projected thereonto by the projector but also transmit light at other wavelengths in the visible spectrum such that a driver and/or occupant(s) in the vehicle may consume virtual projected content by directing their gaze through the windscreen but also view a field ahead of the vehicle by looking beyond the windscreen, such as descried above.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system for serving augmented visual content to a user comprising:
a visor comprising:
a substrate comprising a transparent material; and
a reflective coating applied across the substrate, configured to selectively reflect visible light within a first reflection channel, and configured to transmit wavelengths of visible light outside of the first reflection channel, the first reflection channel spanning a first narrow band of wavelengths;
a projection system configured to project visual content in a first output channel onto an interior surface of the visor, the first output channel comprising a first peak-power wavelength of visible light within the first reflection channel and excluding wavelengths of visible light outside the first reflection channel; and
a support structure configured to locate the visor on a head of the user with the visor in a field of view of the user and configured to locate the projection system relative to the visor.

2. The system of claim 1, wherein the reflective coating is configured to selectively reflect visible light within the first reflection channel spanning the first narrow band of wavelengths of visible light distinct from wavelengths of visible light predominantly reflected passively by road signs and predominately output actively by traffic signals in a geographic region occupied by the system.

3. The system of claim 1:
wherein the support structure comprises a helmet, defines an interior volume and an aperture proximal an anterior end of the helmet, and locates the visor adjacent the aperture; and
wherein the projection system is configured to project visual content comprising dynamic telemetry data onto the visor.

4. The system of claim 3:
wherein the visor is pivotably coupled to the helmet and configured to enclose the aperture; and
wherein the projection system is fixedly coupled to the visor.

5. The system of claim 1:
wherein the reflective coating is configured to reflect visible light predominantly at a first center wavelength within the first reflection channel at an operating temperature; and
wherein the projection system comprises a first light source configured to output visible light predominantly at the first peak-power wavelength approximating the first center wavelength at the operating temperature.

6. The system of claim 5:
wherein the reflective coating is configured to reflect visible light within the first reflection channel defining a full-width half-maximum reflection wavelength band less than twenty nanometers in width; and
wherein the first light source is configured to output visible light within the first output channel defining a full-width half-maximum output wavelength band less than twenty nanometers in width, the full-width half-maximum output wavelength band overlapping the full-width half-maximum reflection wavelength band.

7. The system of claim 6:
wherein the reflective coating comprises a notched dielectric coating; and
wherein the projection system comprises:
the first light source comprising a light-emitting diode; and
a liquid-crystal element interposed between the first light source and the visor.

8. The system of claim 1:
wherein the projection system is configured to project visible light onto the visor over a range of angles of incidence; and
wherein the reflective coating is configured to reflect visible light within the first reflection channel of width sufficient to reflect at least a minimum threshold power of visible light, in the first output channel output by the projection system, incident on the visor over the range of angles of incidence.

9. The system of claim 1:
wherein the reflective coating is further configured:
to selectively reflect visible light within a second reflection channel spanning a second narrow band of wavelengths distinct and offset from the first narrow band of wavelengths defining the first reflection channel; and
to selectively reflect visible light within a third reflection channel spanning a third narrow band of wavelengths distinct and offset from the first narrow band of wavelengths defining the first reflection channel and the second narrow band of wavelengths defining the second reflection channel;
wherein the projection system is configured to project a first color component of an image onto the visor via the first output channel, a second color component of the image onto the visor via a second output channel, and a third color component of the image onto the visor via a third output channel;
wherein the second output channel comprises a second peak-power wavelength of visible light within the second reflection channel and excludes wavelengths of visible light outside the second reflection channel; and
wherein the third output channel comprises a third peak-power wavelength of visible light within the third reflection channel and excludes wavelengths of visible light outside the third reflection channel.

10. The system of claim 9, wherein the reflective coating is configured:
to selectively reflect visible light within the first reflection channel spanning approximately 635 nanometers to 645 nanometers;
to selectively reflect visible light within the second reflection channel spanning approximately 525 nanometers to 545 nanometers; and
to selectively reflect visible light within the third reflection channel spanning approximately 455 nanometers to 475 nanometers.

11. The system of claim 9:
wherein the support structure comprises a helmet, defines an interior volume and an aperture proximal an anterior end of the helmet, and locates the visor over the aperture;
further comprising a camera arranged on the helmet and configured to capture color video frames of a field extending outwardly from a posterior end of the helmet; and
wherein the projection system is configured to project color video frames captured by the camera onto the visor via the first output channel, the second output channel, and the third output channel according to an additive color model.

12. A system comprising:
a visor arranged across the aperture and comprising a transparent material;
a projection system configured to project visible light within a first output channel and within a second output channel, in the form of a composite color image, onto the visor, the first output channel spanning a first band of wavelengths of visible light and the second output channel spanning a second band of wavelengths of visible light distinct and offset from the first band of wavelengths of visible light;
a reflective coating:
applied across the visor;
configured to selectively reflect wavelengths of incident visible light, incident within a first reflection channel overlapping the first output channel;
configured to selectively reflect wavelengths of incident visible light within a second reflection channel overlapping the second output channel, the second reflection channel distinct and offset from the first reflection channel; and
configured to transmit wavelengths of visible light outside of the first reflection channel and the second reflection channel.

13. The system of claim 12, wherein the reflective coating is configured to selectively reflect visible light within the first reflection channel spanning the first band of wavelengths of visible light and within the second reflection channel spanning the second band of wavelengths of visible light distinct from wavelengths of visible light predominantly reflected passively by road signs and predominately output actively by traffic signals in a geographic region occupied by the system.

14. The system of claim 12:
further comprising:
a helmet defining an interior volume, defining an aperture proximal an anterior end of the helmet, and supporting the visor and the projection system; and
a camera coupled to the helmet and configured to capture a color image of a field extending outwardly from a posterior end of the helmet;
wherein the projection system projects a first color component of the color image onto the visor via the first output channel and projects a second color component of the color image onto the visor via the second output channel; and
wherein the reflective coating:
reflects incident visible light in the first output channel and in the second output channel, output by the projection system, toward the interior volume; and
passes ambient visible light outside of the first reflection channel and the second reflection channel toward the interior volume.

15. The system of claim 12:
wherein the projection system projects visible light within the first output channel comprising a first peak-power wavelength of visible light within the first reflection channel and excluding wavelengths of visible light substantially outside the first reflection channel; and
wherein the projection system projects visible light within the second output channel comprising a second peak-power wavelength of visible light within the second reflection channel and excluding wavelengths of visible light substantially outside the second reflection channel.

16. The system of claim 12:
wherein the reflective coating comprises a notched dielectric coating configured:
to reflect visible light within the first reflection channel defining a first full-width half-maximum reflection wavelength band less than twenty nanometers in width; and
to reflect visible light within the second reflection channel defining a second full-width half-maximum reflection wavelength band less than twenty nanometers in width; and
wherein the projection system comprises:
a first light source configured to output visible light within the first output channel defining a first full-width half-maximum output wavelength band less than twenty nanometers in width, the first full-width half-maximum output wavelength band overlapping the first full-width half-maximum reflection wavelength band; and
a second light source configured to output visible light within the second output channel defining a second full-width half-maximum output wavelength band less than twenty nanometers in width, the second full-width half-maximum output wavelength band overlapping the second full-width half-maximum reflection wavelength band.

17. The system of claim 12:
wherein the reflective coating is configured:
to selectively reflect visible light within the first reflection channel spanning approximately 635 nanometers to 645 nanometers;
to selectively reflect visible light within the third reflection channel spanning approximately 455 nanometers to 475 nanometers; and
wherein the projection system is configured:
to output visible light in the first output channel exhibiting a peak-power wavelength of approximately 640 nanometers at an operating temperature; and
to output visible light in the second output channel exhibiting a peak-power wavelength of approximately 465 nanometers at the operating temperature.

18. A method comprising:
at a projection system:
projecting visible light within a first band of output wavelengths onto a visor, the first band of output wavelengths corresponding to a first color component; and
projecting visible light within a second band of output wavelengths onto the visor, the second band of output wavelengths corresponding to a second color component and distinct and offset from the first band of output wavelengths;
at a visor:
reflecting incident visible light within a first band of reflection wavelengths, the first band of reflection wavelengths overlapping the first band of output wavelengths;
reflecting incident visible light within a second band of reflection wavelengths, the second band of reflection wavelengths overlapping the second band of output wavelengths and distinct and offset from the first band of reflection wavelengths;
transmitting visible light outside of the first band of reflection wavelengths and outside of the second band of reflection wavelengths.

19. The method of claim 18, wherein reflecting incident visible light within the first band of reflection wavelengths and within the second band of reflection wavelengths comprises selectively reflecting visible light within the first band of reflection wavelengths and within the second band of reflection wavelengths distinct from wavelengths of visible light predominantly reflected passively by road signs and predominately output actively by traffic signals in a geographic region occupied by the visor.

20. The method of claim 18:
further comprising, at a camera arranged in a helmet containing the projection system and the visor, recording a color image of a field extending outwardly from a posterior end of the helmet, the color image comprising a first color channel and a second color channel;
wherein projecting visible light within the first band of output wavelengths onto the visor comprises projecting the first color channel of the color image, within the first band of output wavelengths, onto the visor; and
wherein projecting visible light within the second band of output wavelengths onto the visor comprises projecting the second color channel of the color image, within the second band of output wavelengths, onto the visor.
